(19) United States
(12) Patent Application Publication
(10) Pub. No.: US 2003/0159328 A1
(43) Pub. Date: Aug. 28, 2003

(54) Plastic worm shroud

(76) Inventor: Thomas W. Acker, Dunnellon, FL (US)

Correspondence Address: DONALD R. BAHR, 2608 MERIDA LN, TAMPA, FL, 33618, US

(21) Appl. No.: 10/335,568

(22) Filed: Jan. 3, 2003

Related U.S. Application Data
(63) Continuation-in-part of application No. 10/082,253, filed on Feb. 26, 2002, now abandoned.

(51) Int. Cl. A01K 85/00

(52) U.S. Cl. 43/42.37

(57) ABSTRACT

Plastic worms are very popular in fishing. These plastic worms are utilized in sport fishing by the attachment of a fish hook to the front of the plastic worm. This plastic worm fish hook combination has a tendency to become entangled, snagged, in debris that is present in the water being fished. In accordance with this invention an elongated flexible shroud is provided, which is positioned over the forward end of the plastic worm. The shroud is capable of securing the plastic worm inside itself. When the shroud is placed over the head of the plastic worm the snagging of the plastic worm is prevented. The shroud of this invention may be further weighted. The purpose of the added weight is to facilitate the casting buoyancy and fish ability of the plastic worm fish hook combination. The shroud may be further colored to enhance the effectiveness of the lure or indicate the weight of the shroud. Because the shroud of this invention is flexible it is able to deform in such a manner that the plastic worm fish hook combination is guided through various types of snags.

### RELATED APPLICATION

This application is a continuation in part application of application Ser. No. 10/082,253 filed Feb. 26, 2002.

### BACKGROUND OF THE INVENTION

The present invention is concerned with sport fishing, more particularly with weed guards for fishing lures. The weed guard of this invention is referred to as a shroud. Plastic worm is a generic term used to describe polymeric reproductions of natural food sources such as worms, night crawlers, ells, salamanders etc.. As fishing lures these plastic worms have been in widespread usage for about 40 years and were made possible by modern polymer technology. In sport fishing a fish hook is secured to the forward portion of the plastic worm whereupon the hook and plastic worm is used to attract and catch fish. This invention is concerned with a flexible shroud which is positioned over the forward terminal end of the plastic worm fish hook combination. The shroud of this invention may further be weighted. The purpose of the shroud of this invention is to prevent the plastic worm, fish hook combination from becoming entangled (snagged) in or on foreign objects as may be contained in the body of water which is being fished, and to unitize the weight, worm and hook combination.

### BRIEF DESCRIPTION OF THE INVENTION

Sport fishing is centuries old. In sport fishing a fisherman positions a bait in the environment where fish are thought to be present. The baits which a fisherman presents are of two types these being natural and artificial. Natural baits are dead or alive living creatures which usually are within the realm of the fishes natural prey. For example worms and minnows are by far the most widely used natural baits. The other class of baits which fisherman use are artificial baits. Artificial baits are usually formed from metal, wood or in recent times polymeric substances. These artificial baits are usually reproductions of natural baits. While it is usually harder to catch fish with artificial baits they have significant advantages over natural bates in that they can be repeatedly used and they do not have to be preserved or kept alive.

Large worms which are generally referred to as night crawlers and ells, are extremely popular as natural baits. With the advent of modern polymer technology over the last four decades it has become possible to create very realistic reproductions of natural baits. These reproductions have formed a new class of baits which are generally referred to as plastic worms. This invention is concerned with an anti snag flexible shroud which aids a fisherman in fishing with plastic worms.

Plastic worms are usually elongated cylindrical structures which are formed from soft flexible polymers which have textures and have characteristics which are similar to that of the natural bait which they are meant to replicate. In fishing with a plastic worm, a metallic fish hook is inserted into the body of the plastic worm.

In any fishing the eternal bane of all fisherman is and has been a snag. A snag is when the fish hook or bait becomes entangled on objects which may be on the water bottom i.e. rocks on the bottom of a lake. Still another type of snag are objects near the body of water being fished. i.e. brush on the side of a stream, or vegetation suspended in the water.

As is mentioned above the metallic fish hook is inserted into the plastic worm. In most usage the pointed barb section of the fish hook is buried into the plastic worm. Because the barb area of the fish hook is buried into the plastic worm it is prevented from snagging with the objects described above.

The barb of the fish hook is buried in the plastic worm while the eye of the fish hook is left protruding from the plastic worm. While the barb of the fish hook is prevented from snagging as described above the protruding eye of the fish hook and the head of the plastic worm are free to snag on foreign objects.

This invention is concerned with a flexible shroud which encompasses the forward portion of the plastic worm, hook and line combination which prevents this combination from becoming snagged during the act of fishing.

### OBJECTS OF THE INVENTION

An object of the invention is an effective way to prevent plastic worms from snagging. Another object of this invention is an anti snag flexible shroud which will encompass and retains the head of a plastic worm.

Still another object of the invention is a flexible shroud which will retain the head of a plastic worm and prevent the plastic worm from snagging.

Another object of the invention is a flexible shroud which will streamline the head of a plastic worm, hook combination and thereby prevent undue turbulence in the water fished.

A further object of this invention is a flexible plastic worm shroud which is capable of encompassing the head of a plastic worm and retain an extraneous weight.

### DESCRIPTION OF THE DRAWINGS

FIG. 1 is a side view showing a prior art rigged weighted plastic worm.

FIG. 2 is a side view showing a prior art rigged weighted plastic worm snagged in a branch.

FIG. 3 is a side view showing prior art rigged plastic worm with a prior art plastic hood.

FIG. 4 is a side view showing the plastic worm shroud of this invention.

FIG. 5 is a cut away side view showing an embodiment of the plastic worm shroud of this invention.

FIG. 6 is a cut away side view showing another embodiment of the plastic worm shroud of this invention.

FIG. 7 is a cut away side view showing still another embodiment of the plastic worm shroud of this invention.

FIG. 8 is a cut away side view showing another embodiment of the plastic worm shroud of this invention wherein a weight is about to be inserted therein.

FIG. 9 is a side view of a rigged plastic worm in accordance with this invention.

FIGS. 10, 11, and 12 are progressive views showing how the flexible plastic worm shroud of this invention avoids snagging.

### DESCRIPTION OF THE PREFERRED EMBODIMENT

As is discussed above this invention is concerned with a flexible shroud which encompasses the forward portion of a lure in order to minimize the possibility that the lure will snag.

As used herein the term snag means any entanglement of a hook, lure, line and weight combination in fishing.

The subject invention is primarily concerned with a type of artificial fishing lure that is generally referred to as a plastic worms. As used in this invention plastic worms are elongated structures which are shaped in the form of a natural bait. The shape of these plastic worms can resemble any number of natural baits i.e. worms, night crawlers, lizards, eels, frogs, salamanders etc. The most popular shape of a plastic worm is that of a night crawler and hence the origin of the term plastic worm. For purposes of this invention plastic worms will be illustrated as reproductions of night crawlers. The plastic worms with which this invention is useful are formed from soft polymers. In fact it was the advent of modern polymer technology that made the plastic worm possible. Because these plastic worms replicate closely the movement of natural bait in an aqueous environment they are very effective in catching fish. As a result of this effectiveness plastic worms have become one of the most popular classes of artificial lures. The subject invention enhances this effectiveness.

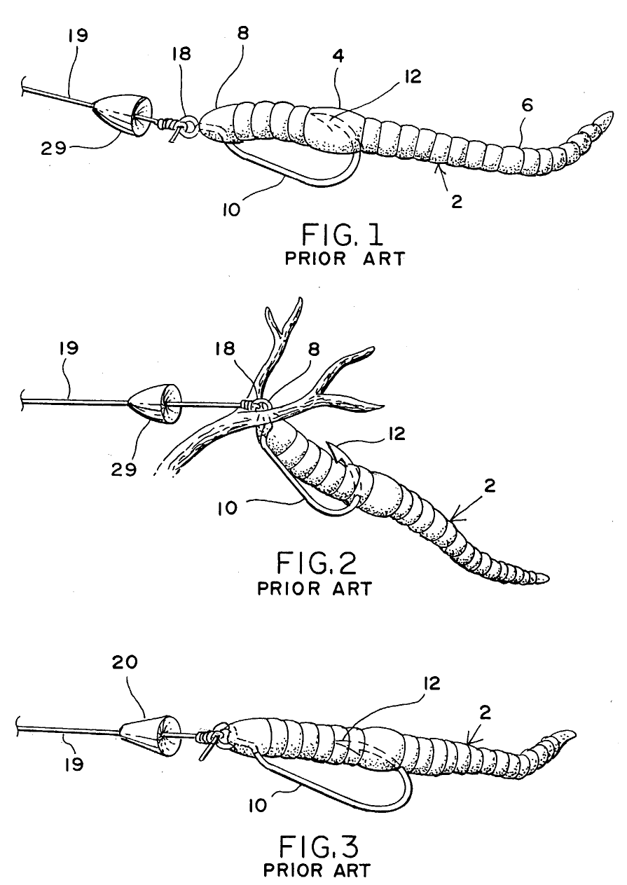

The general method by which plastic worms are rigged can be seen in FIG. 1. An elongated plastic worm 2 comprises body section 4, a tail section 6 and a head section 8. In rigging the barb section 12 of a hook 10 is passed through the plastic worm approximate head section 8. As can be seen barb section 12 is buried in the body of plastic worm 2 and as such it is prevented from snagging when the composite structure is fished. Regardless of the fact that barb section 12 can not snag, the head section 8 along with eye 18 of hook 10 are still free to snag, this snagging is illustrated in FIG. 2. The possibility of head section 8 snagging is further enhanced by the fact that line 19 may exert force on eye 18 in a plane that is not parallel with the axis of plastic worm 2. This non parallel force projection causes plastic worm 2 to have a tendency to snag in a manner as is illustrated in FIG. 2.

Still another prior art structure is illustrated in FIG. 3 wherein a conical hood 20 is placed in front of head section 8 of plastic worm 2. While conical hood 20 enhanced the performance of plastic worm 2 it is deficient in that it does not secure itself to plastic worm 2 and there are no provisions for weighting conical hood 20.

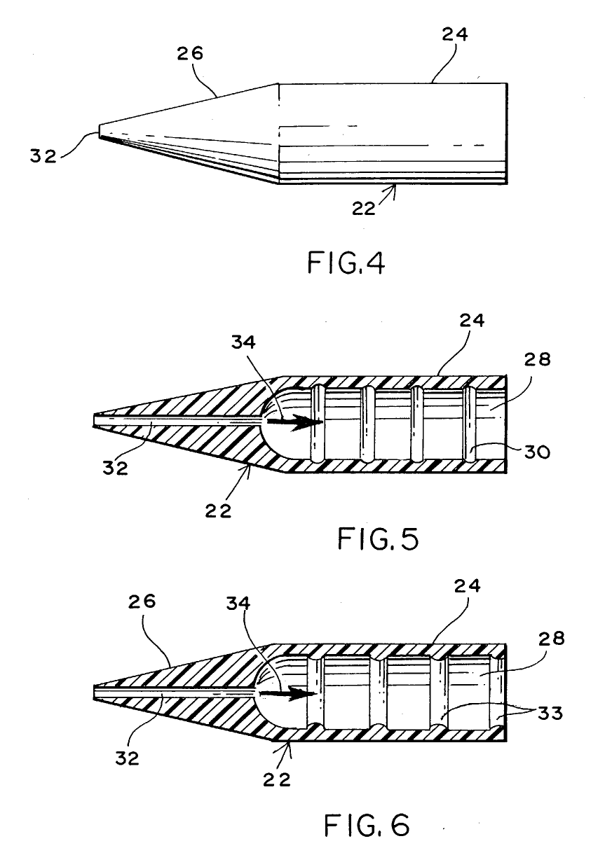

The shroud 22 of this invention is illustrated in FIG. 4. As can be seen shroud 22 has a tubular body section 24 and a conical head section 26. Tubular body section 24 and conical head section 26 are integral.

A section view of shroud 22 is illustrated in FIG. 5. As can be seen from this Figure tubular body section 24, of shroud 22 incorporates a cavity 28. This cavity has a diameter such that head section 8 of plastic worm 2 can be squeezed into cavity 28. Cavity 28 further incorporates a means for securing head section 8 therein. When head section 8 of plastic worm 2 is secured in cavity 28 an integral fishing unit is formed. The illustrated means for securing plastic worm 2 in cavity 28 is one or more annular grooves 30 which are integral with the wall of cavity 28. While annular grooves are illustrated in FIG. 5 these grooves could be replaced by annular projections 33 as are illustrated in FIG. 6. The function of annular grooves 30 or projections 33 is to allow plastic worm 2 to deform in such a manner that it is gripped and thereby secured in cavity 28.

While annular grooves 30 and projections 33 are illustrated it is understood by one skilled in the art that other means may be provided for securing head section 8 of plastic worm 2 in cavity 28. For example head section 8 may be screwed into cavity 28.

As can be seen shroud 22 incorporates an aperture 32 which projects through conical head section 26 to cavity 28. In usage fishing line 19 is passed through aperture 32 in the direction of arrow 34 and into and out cavity 28. Line 19 is then secured to eye 18 of hook 10 with an appropriate knot. Barb section 12 of hook 10 has been secured in the body of plastic worm 2. Head section 8 is then drawn into cavity 28 by applying tension to line 19 and by squeezing head section 8 into cavity 28.

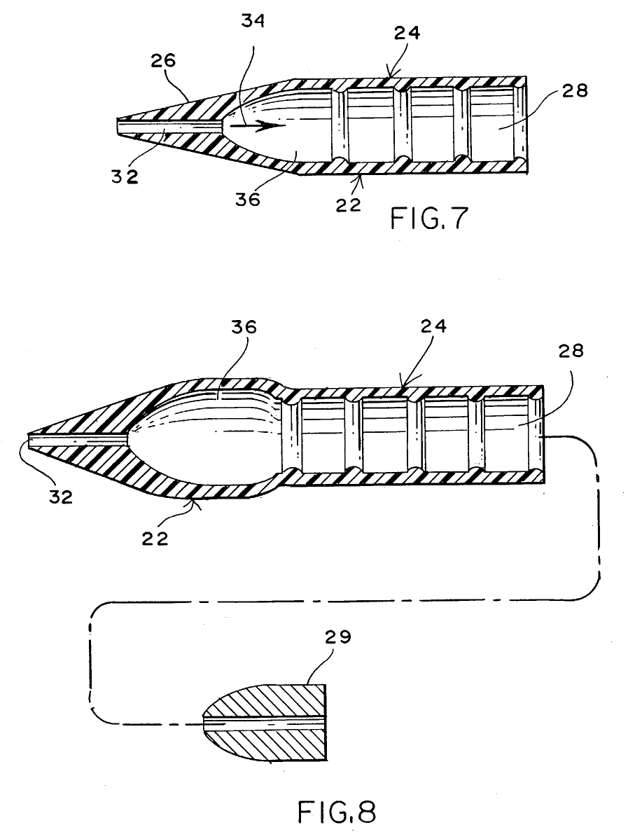

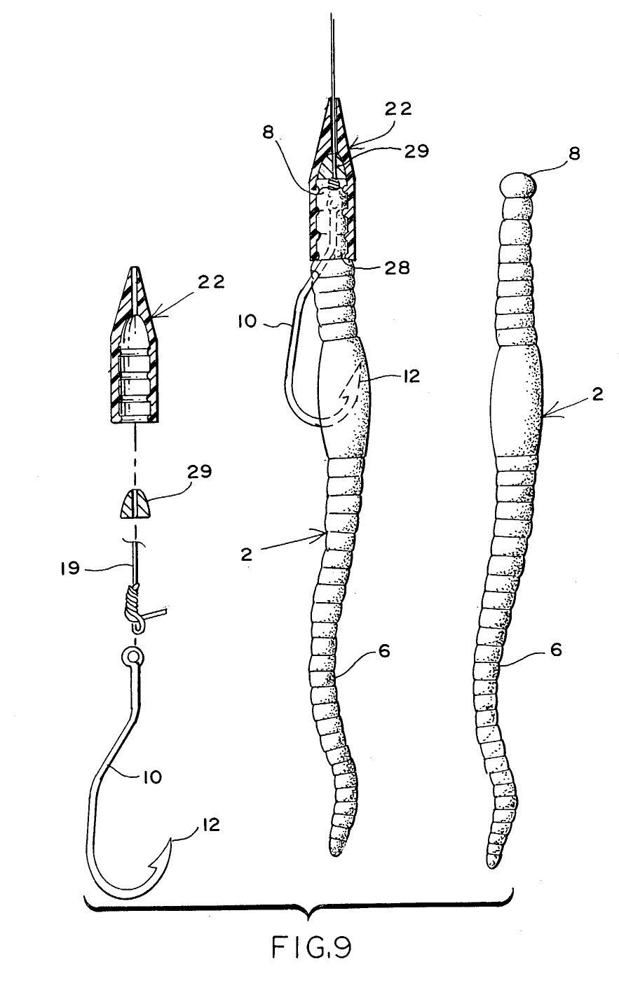

Referring to FIGS. 7 and 8 the tubular body section 24 may further incorporate a cavity 36 into which can be placed an extraneous weight. Small lead weights would normally be placed in cavity 36. The size of these weights 29 can vary in order to alter the fishing and buoyancy characteristics of the plastic worm, hook and line combination.

The weight of the shroud may also be adjusted by filling the polymer from which the shroud is manufactured in place of an extra extraneous weight. Suitable fillers are metallic salts and metal powders. Suitable metal powders are powders of lead, iron, bismuth, tungsten, spent uranium etc. Suitable metallic salts are titanium dioxide, lead oxide, lead carbonate, ferrous oxide etc.

Preferred fillers for use in this invention should have a scott density of from about 6 to about 12 grams per cubic centimeters. The preferred filler for use in this invention is powdered tungsten having a scott density of about 9. grams per cubic centimeters. In order to not adversely affect the physical properties of the polymeric substrate the particle size of the filler should be about 170. microns or less. The preferred particle size of the filler, for use in this invention, is 50. microns or less.

The amount of filler in a given shroud is controlled by desired weight of the shroud and the density of the filler.

For use in this invention the polymer from which the shroud is formed can incorporate from about 20 to about 80 percent filler.

When the shroud of this invention is formed from a silicone polymer and the filler is powdered tungsten having a scott density of about 9. grams per cubic centimeter shrouds having useful weights can be formed from composition which incorporate from about 30 to about 40 percent filler.

While the shroud of this invention is illustrated as having a circular cross section it is understood by one skilled in the art that it could have other cross sections.

Suitable polymers from which shroud 22 may be formed are non rigid, polyurethanes, polystyrene, polyethylene, polypropylene, polyvinyls, silicones etc. Polyvinylchloride and silicones are preferred polymers for use in forming shroud 22.

The Shore A hardness of the polymer from which shroud 22 is formed should be slightly greater than the Shore A hardness of the plastic worm 2. That is shroud 22 should be slightly stiffer and harder than plastic worm 2 such that when head section 8 is pushed into cavity 28 the shroud retains its shape and head section 8 deforms into annular grooves 30 or projections 33. For most plastic worms it is preferred that the Shore A hardness of the shroud be from about 20 to 60 with a preferred Shore A hardness being 43.

Further the polymer from which the flexible shroud 22 is formed should have an elongation percentage of from about 100 to about 900 percent. The preferred elongation percentage is about 600%. The tear strength of the polymer from which flexible shroud 22 is formed can be from about 50 to about 500 psi, with a more preferred range being about 200 to about 230 psi.

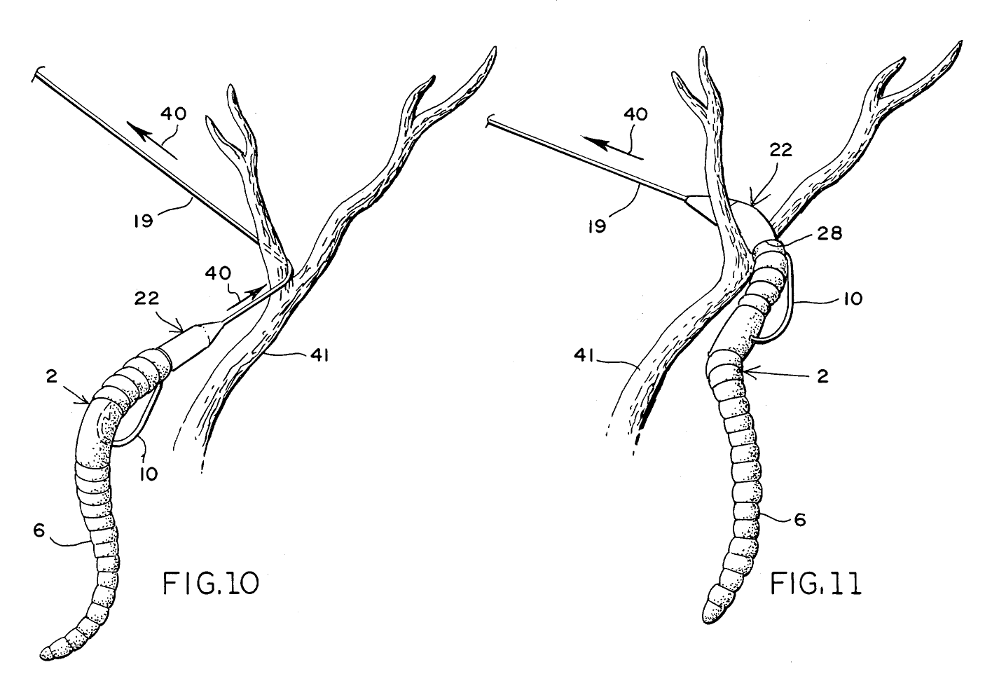

The most important physical property of the polymer from which shroud 22 is formed is the flexural property of this polymer. It is the ability of shroud 22 to deform or flex which allows the composite lure assembly to slither through various types of snags, as is discussed herein below in connection with FIGS. 10-12. The modulus of elasticity of a polymer is the ratio of strain to stress as a material is deformed under a dynamic load. It is a measure of the softness or stiffness of the polymer from which shroud 22 is formed. For use in this invention shroud 22 can be formed from a polymeric material having a modulus of elasticity in lbs./sq. in. from about 50 to about 400, a more preferred range is from about 100 to about 300, a most preferred range is from about 175 to about 250, with a most preferred modulus of elasticity being 230.

For most plastic worms it is preferred that shroud 22 have a length of about 1.25 inches. The preferred diameter of tubular body section 24 is about 0.350 inches and the diameter of cavity 28 is about 0.250 inches. Further it is preferred that the axial length of tubular body section 24 be about 0.75 inches and the axial length of conical head section be about 0.50 inches.

It is preferred that the ratio of axial length of the conical head section, to that of the diameter of the tubular body portion be from about 1. to about 2.5 with a preferred ratio being 1 to 1.5.

Flexible shroud 22 in accordance with this invention may be colored to coordinate with the color of plastic worm 2 or to indicate the weight of the shroud. For example one color could be used to indicate that the weight of the shroud is 1/32 oz, another color for 1/16 oz and still another color for ⅛ oz.

FIG. 9 shows the component parts of this invention and how a plastic worm 2 is rigged in a shroud 22 in accordance with this invention. The cut away section of shroud 22 shows how it grips head section 8 of worm 2.

FIGS. 10, 11 and 12 are sequential and show how flexible shroud 22 prevents a rigged plastic worm 2 from becoming entangled in a snag 41 which is depicted as a tree branch. In FIG. 10 the rigged plastic worm 2 is approaching snag 41. Arrows 40 illustrate the angular forces which are applied to the rigged plastic worm 2 by line 19.

As can be seen from FIG. 11 as the rigged plastic worm 2 engages snag 41 shroud 22 deforms or bends because it is flexible. This deformation or bending allows force, as is illustrated by arrow 40, to be transferred to rigged worm 2 in such a manner that the rigged structure can slither through snag 41.

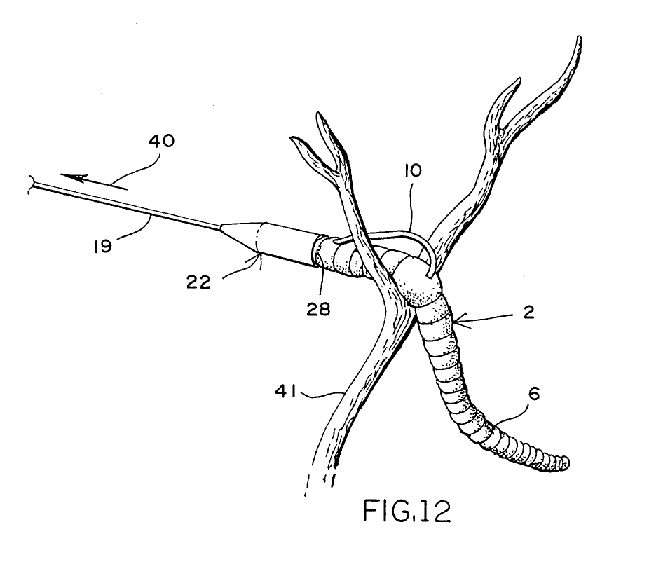

From FIG. 12 it can be seen how the body of plastic worm 2 continue to slither through and around snag 41. This maneuvering around snag 41 is possible because shroud 22 is flexible.

From FIGS. 10-12 it can be seen that eye 18 of hook 10 and head section 8 of worm 2 never come into contact with snag 41 as they are completely enclosed in shroud 22. Because eye 18 is enclosed in shroud 22 it can not bind on snag 41.

The above descriptions and drawings are illustrative of modifications that can be made without departing from the present invention, the scope of which is to be limited only by the following claims.

What is claimed is:

1. A flexible polymeric shroud for a plastic worm type of fishing lure which comprises;
a. an elongated polymeric structure having a tubular hollow body portion one end of which is open, wherein the hollow body portion is adapted to contain and secure the forward portion of a plastic worm fishing lure,
b. integral with the forward portion of the tubular hollow body portion is a conical forward portion which incorporates an axial aperture which communicates with the inside of the hollow body portion, wherein the axial aperture is of such a size that fishing line can be passed there through
wherein the shroud is formed from a polymeric material having a modulus of elasticity of from about 50 to about 400 lbs. per sq. in.

2. The shroud of claim 1 wherein the inner perimeter of the hollow body portion further incorporates means for securing the forward portion of the plastic worm therein.

3. The shroud of claim 2 wherein the means for securing the forward portion of the plastic worm comprises one or more of annular grooves which are integral with the inner perimeter of the hollow body portion.

4. The shroud of claim 2 wherein the means for securing the forward portion of the plastic worm comprises a plurality of annular ridges which are integral with the inner perimeter of the hollow body portion.

5. The shroud of claim 1 wherein the shroud further incorporates a weighting means whereby the weight of the shroud may be increased.

6. The shroud of claim 2 wherein the shroud further incorporates a weighting means whereby the weight of the shroud may be increased.

7. The shroud of claim 3 wherein the shroud further incorporates a weighting means whereby the weight of the shroud may be increased.

8. The shroud of claim 4 wherein the shroud further incorporates a weighting means whereby the weight of the shroud may be increased.

9. The shroud of claim 5 wherein the shroud further incorporates a weighting means whereby the weight of the shroud may be increased.

10. The shroud of claim 5 wherein the weighting means comprises, a powder which has a scott density greater than 6 grams per cubic centimeters, which is formulated into the composition from which the shroud is formed.

11. The shroud of claim 6 wherein the weighting means comprises a metallic powder which is formulated into the composition from which the shroud is formed.

12. The shroud of claim 7 wherein the weighting means comprises a metallic powder which is formulated into the composition from which the shroud is formed.

13. The shroud of claim 8 wherein the weighting means comprises a metallic powder which is formulated into the composition from which the shroud is formed.

14. The shroud of claim 9 wherein the weighting means comprises a metallic powder which is formulated into the composition from which the guard is formed.

15. The shroud of claim 5 wherein the weighting means is a metallic weight which is placed in a cavity which is integral with the shroud.

16. The shroud of claim 6 wherein the weighting means is a metallic weight which is placed in a cavity which is integral with the shroud.

17. The shroud of claim 7 wherein the weighting means is a metallic weight which is placed in a cavity which is integral with the shroud.

18. The shroud of claim 8 wherein the weighting means is a metallic weight which is placed in a cavity which is integral with the shroud.

19. The shroud of claim 5 wherein the shroud is further colored and the coloration is used as an indicia of the weight of said shroud, or to match or enhance the color of the worm.

20. The shroud of claim 6 wherein the shroud is further colored and the coloration is used as an indicia of the weight of said shroud, or to match or enhance the color of the plastic worm.

21. The shroud of claim 7 wherein the shroud is further colored and the coloration is used as an indicia of the weight of said shroud, or to match or enhance the color of the plastic worm.

22. The shroud of claim 8 wherein the shroud is further colored and the coloration is used as an indicia of the weight of said shroud, or to match or enhance the color of the plastic worm.

23. The shroud of claim 1 wherein the ratio of axial length of the conical head section to the diameter of the tubular body portion is from about 1 to about 2.5 and the shore A hardness is from about 20 to about 60.

24. The shroud of claim 2 wherein the ratio or axial length of the conical head section to the diameter of the tubular body section to the diameter of the tubular body portion is from about 1 to about 2.5 and the Shore a hardness is about 20 to about 60.

25. The shroud of claim 3 wherein the ratio of axial length of the conical head section to the diameter of the tubular body portion is from about 1 to about 2.5.

26. The shroud of claim 5 wherein the ratio of axial length of the conical head section to the diameter of the tubular body portion is from about 1 to about 2.5.

27. The shroud of claim 1 wherein the modulus of elasticity of the polymer from which the shroud is formed is from about 100 to about 300 lbs. per sq. in.

28. The shroud of claim 1 wherein the modulus of elasticity of the polymer from which the shroud is formed is from about 175 to about 250 lbs. per sq. in.

29. The shroud of claim 1 wherein the shroud is formed from a silicone polymer having a modulus of elasticity of 230.

30. The shroud of claim 1 wherein the shroud is formed from a silicone polymer having a modulus of elasticity of about 230 and the silicone polymer is filled with from about 30 to about 40 percent of powdered tungsten having a scott density of about 9 grams per cubic centimeters.
